(19) United States
(12) Patent Application Publication
(10) Pub. No.: US 2008/0005732 A1
(43) Pub. Date: Jan. 3, 2008

(54) Method and System for Integrating Software Update Services with Software Applications

(76) Inventor: Robert F. Coon, Westchester, IL (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/382,899

(22) Filed: May 11, 2006

(51) Int. Cl. G06F 9/44

(52) U.S. Cl. 717/168

(57) ABSTRACT

A method and system for integrating software update services with software applications are disclosed. In one embodiment, the method comprises receiving as inputs a software update service and a software application. Information regarding the software application is collected. An integrated application is generated based on the collected information. The integrated application includes the collected information, the software application, and a runtime module for the software update service.

### FIELD OF THE INVENTION

The field of the invention relates generally to computer systems and more particularly relates to a method and system for integrating software update services with software applications.

### BACKGROUND OF THE INVENTION

Generally, a software update service allows a user to check for updates to a software application, download or otherwise access the updates, and install the updates on a computer system. To use the software update service, the user may launch the update service directly or create a shortcut within the software application to launch the update service. If the software update service is integrated with the software application, the software application may be able to check for, access, and/or install updates directly instead of relying on a separate update service application.

Integrating a software update service with a software application, however, generally requires some development effort by the software applications provider. For example, the application provider may implement source code in the software application for requesting the software update service's application programming interfaces (“APIs”) to check for, access, and/or install updates.

This development effort may not present a problem for software programmers who have the skill, time and resources to implement additional code to integrate a software update service with an application. Nevertheless, such a development effort may be costly for application providers who wish to evaluate the result of the integration before deciding to procure a software update service. In addition, the individuals who make the procurement decisions may not be software programmers skilled in writing software. Thus, manually integrating a software update service with a software application presents a challenge for application providers who wish to evaluate the desirability of a particular software update service. Application providers may not be able to experience the various features of a software update service and effectively evaluate the potential value of integrating the update service with software applications.

### SUMMARY

A method and system for integrating software update services with software applications are disclosed. In one embodiment, the method comprises receiving as inputs a software update service and a software application. formation regarding the software application is collected. An integrated application is generated based on the collected information. The integrated application includes the collected information, the software application, and a runtime module for the software update service.

The above and other preferred features, including various novel details of implementation and combination of elements, will now be more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 illustrates a block diagram of an exemplary update network including a software update service that is integrated with a software application to form an integrated application, according to one embodiment of the present invention.

FIG. 2 illustrates a block diagram of an exemplary integrated update service including a design-time module, according to one embodiment of the present invention.

FIG. 3 illustrates a block diagram of an exemplary runtime module, according to one embodiment of the present invention.

FIG. 4 illustrates a flow diagram of an exemplary process of managing and organizing software package installations, according to one embodiment.

FIG. 5 illustrates an exemplary computer architecture for use with the present system, according to one embodiment.

### DETAILED DESCRIPTION

A method and system for integrating software update services with software applications are disclosed. In one embodiment, the method comprises receiving as inputs a software update service and a software application. Information regarding the software application is collected. An integrated application is generated based on the collected information. The integrated application includes the collected information, the software application, and a runtime module for the software update service.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer systems registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

According to one embodiment, the following terms may have the following meanings without regard to its upper or lower case usage. However, one of ordinary skill would understand that additional embodiments may contemplate additional terms and/or variation of these terms.

“Application launcher module” may mean any combination of software, firmware, and/or hardware that launches a software application.

“Design-time module” may mean any combination of software, firmware, and/or hardware that receives as inputs a software application, a software update service, and information regarding the software application to generate an integrated application.

“Hook module” may mean any combination of software, firmware, and/or hardware that intercepts one or more messages to a software application to perform certain tasks in response to the intercepted messages.

“Information collection module” may mean any combination of software, firmware, and/or hardware that collects information regarding a software application.

“Information reader module” may mean any combination of software, firmware, and/or hardware that extracts the information collected by the information collection module.

“Integrated application” may mean a software application integrated with a software update service such that the software application is able to check for, access, and/or install updates to the software application.

“Integration module” may mean any combination of software, firmware, and/or hardware that integrates a software application with a software update service based on information regarding the software application.

“Runtime module” may mean any combination of software, firmware, and/or hardware that implements the runtime behavior of the integrated application.

“Software update service” or “update service” may mean any combination of software, firmware, and/or hardware that checks for, accesses, and/or installs updates to a software application on a computer system.

“Storage module” may mean any combination of software, firmware, and/or hardware that stores profile information of an application provider.

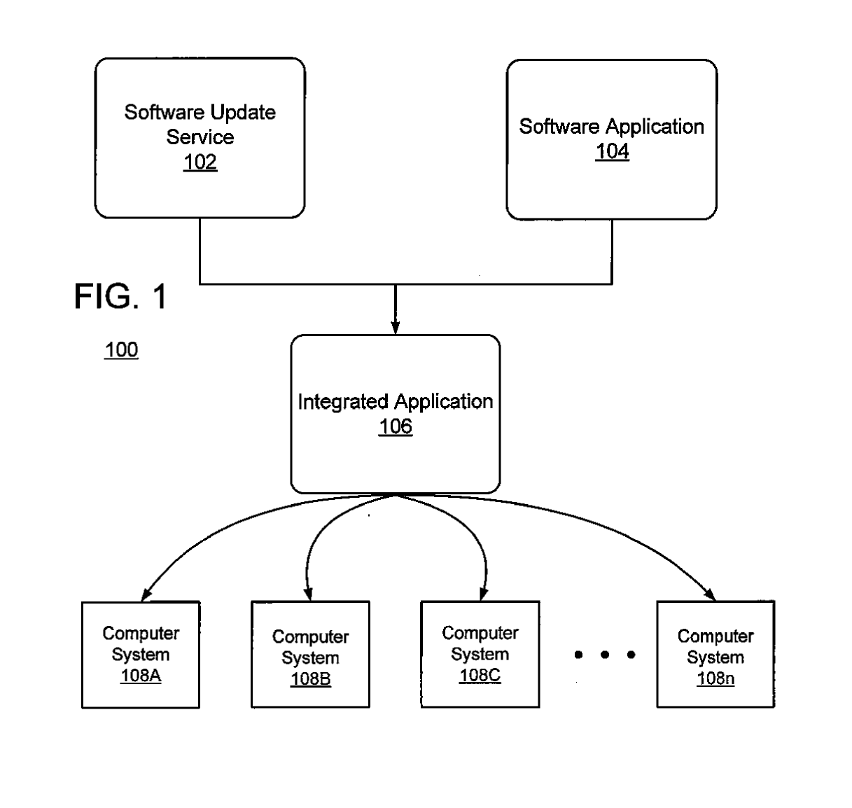

FIGS. 1-3 illustrate block diagrams of an exemplary software update service system, according to embodiments of the present invention. In addition to software update service systems, it is to be appreciated that other systems employing the various teachings herein may also be used to practice the various aspects of the present invention, and as such, are considered to be within its full scope.

FIG. 1 illustrates a block diagram of an exemplary update network 100 including a software update service 102 that is integrated with a software application 104 to form an integrated application 106, according to one embodiment of the present invention. Integrated application 106 is distributed to and installed on one or more computer systems 108. A computer system 108 can utilize the features and functionalities of software application 104 in integrated application 106. In addition, software update service 102 allows software application 104 to check for the existence of updates to software application 104, access the updates, and install the updates on a computer system 108. In particular, if computer system 108 launches software application 104 (or selects certain features of software application 104), it automatically requests software update service 102 to check for, access, and/or install the updates. For example, software application 104 may all the appropriate APIs of software update service 102. Thus, integrated application 106, by relying on software update service 102, can provide various software update services to computer system 108 without installing and executing a separate update program on computer system 108.

Although not shown in FIG. 1, other components and/or systems may also be utilized in conjunction with other embodiments. For example, computer systems 108 may be coupled to a network. The network may be a local area network (“LAN”), wide area network (“WAN”), virtual private network (“VPN”), or other network that is configured to transmit data to or from the computer systems. Integrated application 106 may be distributed to computer systems 108 via the network. In addition, software update service 102 may check for the existence of updates to software application 104 and download such updates on computer systems 108 via the network (e.g., the Internet).

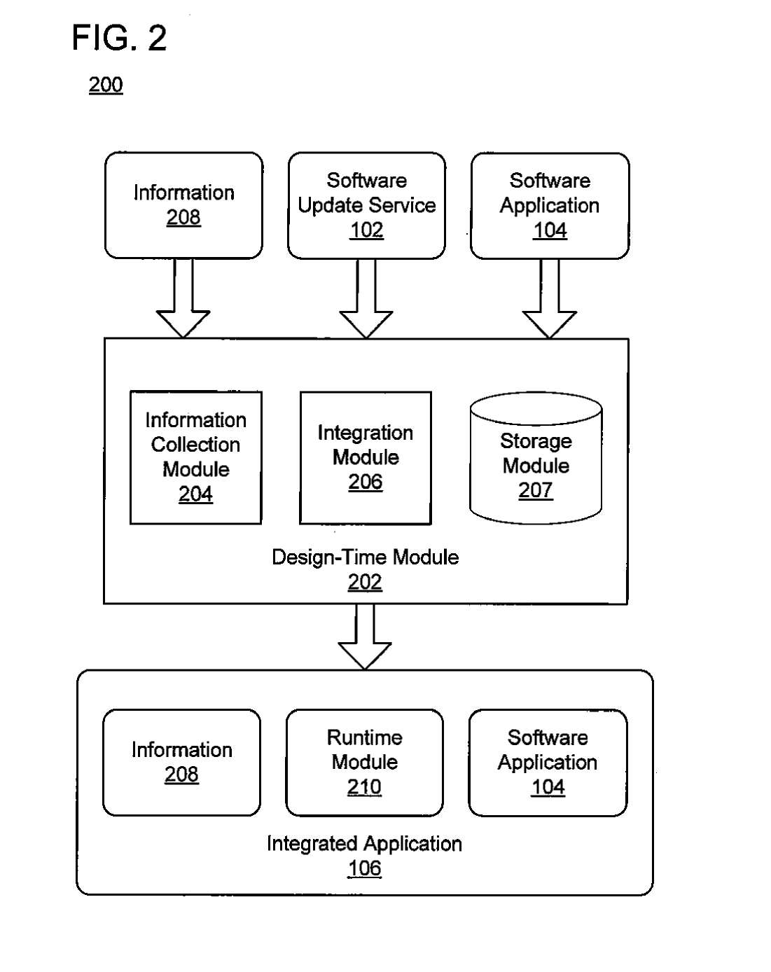

FIG. 2 illustrates a block diagram of an exemplary integrated update service 200 including a design-time module 202, according to one embodiment of the present invention. Design-time module 202 accepts software update service 102 and software application 104 as inputs. Design-time module 202 may reside on a computer system of the provider of software application 104. For example, software application 104 may be Microsoft Word, which is to be integrated with an update service by the application provider of Microsoft Word. Design-time module 202 is configured to integrate software update service 102 with software application 104 to generate integrated application 106. As shown in FIG. 2, design-time module 202 includes an information collection module 204, an integration module 206, and a storage module 207. Design-time module 202, information collection module 204, integration module 206, and storage module 207 may be software, firmware, and/or hardware or any combination of software, firmware, and/or hardware. One of ordinary skill in the art will appreciate that the organization of the modules of update service 200 may be arranged, integrated or distributed in various ways. Various modules may be combined into one or more modules and may be distributed among different computer systems or modules. For example, information collection module 204 may be integrated with integration module 206 and/or storage module 207. Similarly, storage module 207 may be integrated with integration module 206.

According to one embodiment, information collection module 204 receives information 208 from, for example, a provider of software application 104. The provider may specify information 208 via a computer network such as the Internet or via a software module installed on the provider's computer system. Thus, information collection module 204 may receive information 208 from the application provider via a command line tool or a wizard installed on the application provider's computer system. Information collection module 204 may also receive information 208 from the application provider via the Internet using, for example, an ActiveX control or a component object model (“COM”) interface.

Information 208 may include an execution path to software application 104 and the product name, product code and/or product version of software application 104. In one embodiment, information collection module 204 displays a list of software applications installed on the computer system for the application provider to choose a particular application to be integrated with software update service 102. Information 208 may also specify that integrated application 106 should check for, access and/or install updates to software application 104 when a computer system 108 launches integrated application 106, at another specified time, or in response to certain events (e.g., in response to the selection of a menu item in integrated application 106). Information 208 may specify that updates to software application 104 are to be accessed and/or installed on computer systems 108 before or after launch of integrated application 106. Information 208 may further specify that the update process (i.e., the checking for, accessing and/or installation of updates) should recur within a specified time interval. In addition, information 208 may limit the update process to certain types of updates (e.g., critical updates to software application 104).

According to one embodiment of the invention, the application provider can add one or more features (e.g., menu items) to software application 104. Thus, information 208 may include the identifier and/or text of the features to be added to software application 104. For example, the application provider may add a “Check for Updates” item in the “Help” menu of software application 104. In that case, information 208 may specify that a menu item having the text “Check for Updates” should be added in the menu having the text “Help” or having a specified identifier. If information 208 specifies that integrated application 106 should check for, access, and/or install updates in response to the selection of a feature but does not specify the identifier and/or text of the feature, a default feature having a predetermined identifier and/or text will be added to software application 104. For example, a default “Check for Updates” item may be automatically added to the “Help” menu of software application 104 if the application provider did to specify which feature of software application 104 which, if selected, will request software update service 102 to check for, access and/or install updates.

Information 208 may indicate that the application provider replace an existing feature of software application 104 with a new feature (e.g., replacing the “About” menu item with the “Check for Updates” menu item). Information 208 can specify the location where the features are to be added or replaced in software application 104. According to one embodiment, information collection module 204 is configured to visually depict the various features (e.g., menus) of software application 104 so the application provider can click and choose where to add or replace features of software application 104.

In another embodiment, information 208 specifies that computer actions are to be recorded by integrated application 106. For example, information 208 may specify that upon launch of integrated application 106 or upon other events (also specifiable in information 208), integrated application 106 records computer actions with respect to specified features of integrated application 106 (e.g., the “Check for Updates” menu item). Information 208 can further specify the identifier and/or text of the features of integrated application 106 for which computer actions are to be recorded. Information 208 may also specify the string to be recorded with respect to a type of computer action. For example, the string “checked for updates” may be recorded if the “Check for Updates” menu item is clicked.

In addition to checking for updates, information 208 may specify that integrated application 106 should check for certain information regarding integrated application 106 in response to the selection of specified features of integrated application 106 (e.g., the “Check for Updates” menu item). This information includes technical support, training offerings, software documentation, diagnostic tools, special marketing offers, etc.

Design-time module 202 may include a storage module 207 that stores an application provider's profile information. Profile information includes the settings in information 208 with respect to the application provider. Accordingly, by receiving the unique identifier about the application provider, information collection module 204 is configured to automatically generate information 208 based on the application provider's profile information stored in storage module 207.

After information collection module 204 collects information 208, integration module 206 integrates software update service 102 with software application 104. In particular, integration module 206 creates a file that comprises software application 104 appended to the runtime element of software update service 102. Integration module 206 also appends a data stream to software application 104 where the data stream includes information 208. As a result, integration module 206 generates integrated application 106, which includes a runtime module 210, software application 104, and information 208. Furthermore, integration module 206 may store a backup copy of software application 104 in the application provider's computer system.

In an alternative embodiment of the invention, integration module 206 generates integrated application 106 such that integrated application 106 includes runtime module 210, software application 104, information 208, and software update service 102. Information 208 can specify whether to include a copy of software update service 102 in integrated application 106 (e.g., if software update service 102 is not already installed on the computer system from which integrated application 106 is to be launched).

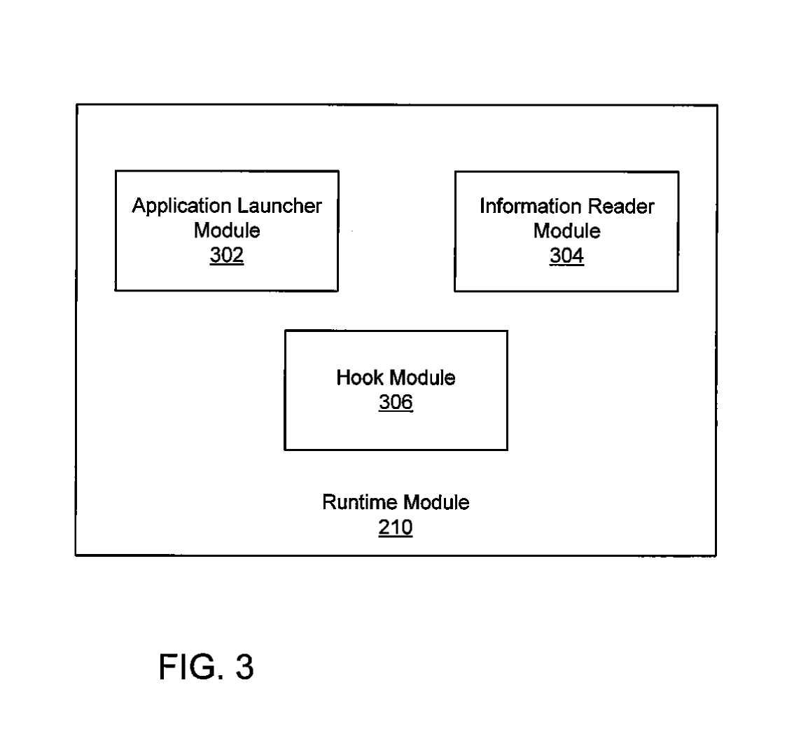

FIG. 3 illustrates a block diagram of an exemplary runtime module 210, according to one embodiment of the present invention. As shown runtime module 210 includes an application launcher module 302, an information reader module 304, and a hook module 306. Runtime module 210, application launcher module 302, information reader module 304, and hook module 306 may be software, firmware, and/or hardware or any combination. of software, firmware, and/or hardware. One of ordinary skill in the art will appreciate that the organization of the modules of runtime module 210 may be arranged, integrated or distributed in various ways. The modules 302-306 maybe combined into one or more modules and may be distributed among different computer systems or modules. For example, application launcher module 302 maybe integrated with information reader module 304 and/or hook module 306. Similarly, hook module 306 maybe integrated with information reader module 304.

After integrated application 106 is provided to a computer system 108 (e.g., of an end-user of integrated application 106 or of an application provider who is evaluating software update service 102), computer system 108 launches runtime module 210 of integrated application 106. Runtime module 210 directs information reader module 304 to extract information 208. Based on information 208, runtime module 210 registers the execution path, product name, product code and/or product version of software application 104 with software update service 102.

Runtime module 210 initiates application launcher module 302. Application launcher module 302 launches software application 104. Hook module 306 (e.g., in the form of dynamically linked library (“DLL”)) is configured to intercept messages to or from software application 104. From an intercepted message, hook module 306 is further configured to extract the identifier and/or text of the feature associated with the message. Hook module 306 then determines whether to take certain actions with respect to the intercepted message by comparing the extracted identifier and/or text against the settings stored in information 208. Thus, based on information 208, hook module 306 may add one or more features to application 104 or replace existing features of application 104 with new features. For example, if the intercepted message is a command to draw the “Help” menu, hook module 306 may add a “Check for Updates” item in the “Help” menu or replace the “About” item with the “Check for Updates” item before application 104 draws the “Help” menu. After the menu item is added or replaced, hook module 306 ignores subsequent messages to draw the menu.

Hook module 306 also determines if integrated application 106 needs to perform certain actions in response to an intercepted message, for example, by comparing the identifier and/or text associated with the message against the settings stored in information 208. Thus, if the “Check for Updates” menu item is clicked, hook module 306 will intercept this message and may request update service 102 to check for, access, and/or install updates to software application 104, based on the settings stored in information 208. In response to the selection of certain features of integrated application 106 (e.g., the “Check for Updates” menu item), hook module 306 may further request the update service 102 to check for other information that may be of interest to a user of integrated application 106, such as technical support, training offerings, software documentation, diagnostic tools, special marketing offers, etc. Based on the settings stored in information 208, integrated application 106 may automatically check for, access, and/or install updates or other information at one or more specified times.

If information 208 specifies the recording of computer actions with respect to certain features of integrated application 106 (e.g., the selection of the “Check for Updates” menu item), hook module 306 intercepts messages sent to such features. Hook module 306 further records the computer actions in a storage via, for example, transaction logging APIs of software update service 102. Based on the settings stored in information 208, hook module 306 can also track the start-up or shut-down of integrated application 106. If information 208 includes a dialog identifier (or other control identifier), hook module 306 can further track how many times a specific dialog (or other control) is displayed and/or track the elapsed tine that the specific dialog (or other control) is displayed. The storage of computer actions is located locally in computer system 108. In response to certain events, such as the start-up or shut-down of integrated application 106, runtime module 210 is configured to send the recorded computer actions to the application provider via, for example, a network. Thus, the application provider can generate reports to analyze usage with respect to specific features of integrated application 106.

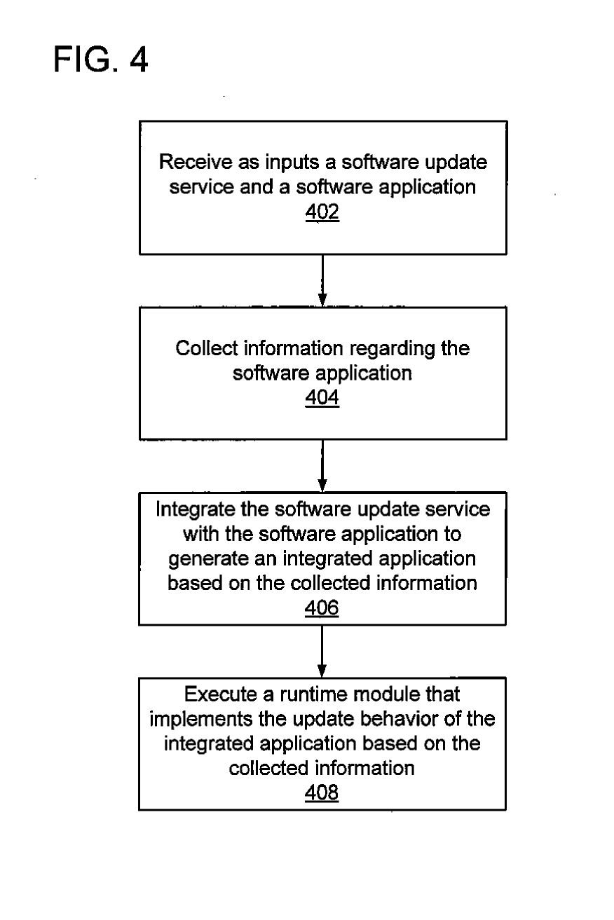

FIG. 4 illustrates a flow diagram of an exemplary process of integrating a software update service with a software application, according to one embodiment. in FIG. 4, a design-time module 202 receives as inputs a software update service 102 and a software application 104. (402) An information collection module 204 collects information 208 regarding software application 104. (404) An integration module 206 integrates software update service 102 with software application 104 to generate an integrated application 106 based on information 208. (406) A runtime module 210 is executed to implement the update behavior of integrated application 106 based on information 208. (408) For example, runtime module 210 is configured to request software update service 102 to check for, access, and/or install updates to software application 104 at a specified time or in response to a specified event.

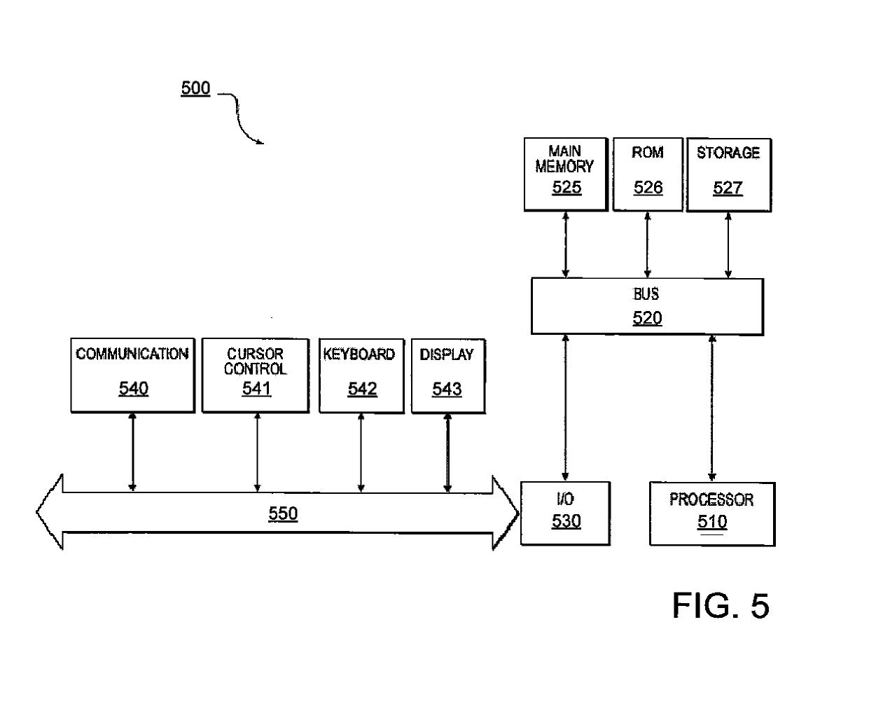

FIG. 5 illustrates an exemplary computer architecture for use with the present system, according to one embodiment. Computer architecture 500 can be used to implement the computer systems described in various embodiments of the invention, including any of the design-time module 202, the information collection module 204, the integration module 206, the storage module 208, the runtime module 210, the application launcher module 302, the information reader module 304, and the hook module 306. One embodiment of architecture 500 comprises a system bus 520 for communicating information, and a processor 510 coupled to bus 520 for processing information. Architecture 500 further comprises a random access memory (RAM) or other dynamic storage device 525 (referred to herein as main memory), coupled to bus 520 for storing information and instructions to be executed by processor 510. Main memory 525 also may be used for storing temporary variables or other intermediate information during execution of instructions by processor 510. Architecture 500 also may include a read only memory (ROM) and/or other static storage device 526 coupled to bus 520 for storing static information and instructions used by processor 510.

A data storage device 527 such as a magnetic disk or optical disc and its corresponding drive may also be coupled to computer system 500 for storing information and instructions. Architecture 500 can also be coupled to a second I/O bus 550 via an I/O interface 530. A plurality of I/O devices may be coupled to I/O bus 550, including a display device 543, an input device (e.g., an alphanumeric input device 542 and/or a cursor control device 541). For example, web pages and business related information may be presented to the user on the display device 543.

The communication device 540 is for accessing other computers (servers or clients) via a network. The communication device 540 may comprise a modem a network interface card, a wireless network interface or other well known interface device, such as those used for coupling to Ethernet, token ring, or other types of networks.

Although the present method and system have been described in connection with a software update service system, one of ordinary skill would understand that the techniques described may be used in any situation where it is to integrate a software update service with a software application.

A method and system for integrating software update services with software applications have been disclosed. Although the present methods and systems have been described with respect to specific examples and subsystems, it will be apparent to those of ordinary skill in the art that it is not limited to these specific examples or subsystems but extends to other embodiments as well.

I claim:

1. A computer-implemented method, comprising:
receiving as inputs a software update service and a software application;
collecting information regarding the software application; and
generating an integrated application based on the collected information, the integrated application including the collected information, the software application, and a runtime module for the software update service.

2. The computer-implemented method of claim 1, wherein the collected information includes a request to check for, access, or install an update to the software application at a specified time or in response to a specified event.

3. The computer-implemented method of claim 2, wherein the integrated application is configured to check for, access, or install the update at the specified time or in response to the specified event.

4. The computer-implemented method of claim 1, wherein the collected information includes a request to add a feature to the software application or to replace an existing feature of the software application with a new feature.

5. The computer-implemented method of claim 4, wherein the runtime module is configured to add the feature to the software application or to replace the existing feature of the software application with the new feature.

6. The computer-implemented method of claim 5, wherein the integrated application is configured to check for, access, or install an update to the software application in response to a user selecting the added feature or the new feature.

7. The computer-implemented method of claim 6, wherein the integrated application is configured to check for one or more of the following information regarding the software application in response to the user selecting the added feature or the new feature: the availability of new or changed technical support and training offering, the availability of new or changed software documentation, the availability of new or changed diagnostic tools, and special marketing offers.

8. The computer-implemented method of claim 1, wherein the collected information includes a request to track user usage of a feature of the integrated application.

9. The computer-implemented method of claim 8, further comprising intercepting one or more messages to or from the integrated application to track the user usage of the feature.

10. A computer-readable medium having stored thereon a plurality of instructions, said plurality of instructions when executed by a computer, cause said computer to perform:
receiving as inputs a software update service and a software application;
collecting information regarding the software application; and
generating an integrated application based on the collected information, the integrated application including the collected information, the software application, and a runtime module for the software update service.

11. The computer-readable medium of claim 10, wherein the collected information includes a request to check for, access, or install an update to the software application at a specified time or in response to a specified event.

12. The computer-readable medium of claim 11, wherein the integrated application is configured to check for, access, or install the update at the specified time or in response to the specified event.

13. The computer-readable medium of claim 10, wherein the collected information includes a request to add a feature to the software application or to replace an existing feature of the software application with a new feature.

14. The computer-readable medium of claim 13, wherein the runtime module is configured to add the feature to the software application or to replace the existing feature of the software application with the new feature.

15. The computer-readable medium of claim 14, wherein the integrated application is configured to check for, access, or install an update to the software application in response to a user selecting the added feature or the new feature.

16. The computer-readable medium of claim 15, wherein the integrated application is configured to check for one or more of the following information regarding the software application in response to the user selecting the added feature or the new feature: the availability of new or changed technical support and training offering, the availability of new or changed software documentation, the availability of new or changed diagnostic tools, and special marketing offers.

17. The computer-readable medium of claim 10, wherein the collected information includes a request to track user usage of a feature of the integrated application.

18. The computer-readable medium of claim 17, wherein the plurality of instructions cause the computer to perform:
intercepting one or more messages to or from the integrated application to track the user usage of the feature.

19. A computer system, comprising:
a processor; and
memory coupled to the processor, the memory storing instructions;
wherein the instructions when executed by the processor cause the processor to:
receiving as inputs a software update service and a software application;
collecting information regarding the software application; and
generating an integrated application based on the collected information, the integrated application including the collected information, the software application, and a runtime module for the software update service.

20. The computer system of claim 19, wherein the collected information includes a request to check for, access, or install an update to the software application at a specified time or in response to a specified event.

21. The computer system of claim 20, wherein the integrated application is configured to check for, access, or install the update at the specified time or in response to the specified event.

22. The computer system of claim 19, wherein the collected information includes a request to add a feature to the software application or to replace an existing feature of the software application with a new feature.

23. The computer system of claim 22, wherein the runtime module is configured to add the feature to the software application or to replace the existing feature of the software application with the new feature.

24. The computer system of claim 23, wherein the integrated application is configured to check for, access, or install an update to the software application in response to a user selecting the added feature or the new feature.

25. The computer system of claim 24, wherein the integrated application is configured to check for one or more of the following information regarding the software application in response to the user selecting the added feature or the new feature: the availability of new or changed technical support and training offering, the availability of new or changed software documentation, the availability of new or changed diagnostic tools, and special marketing offers.

26. The computer system of claim 19, wherein the collected information includes a request to track user usage of a feature of the integrated application.

27. The computer system of claim 26, wherein the instructions cause the processor to:
intercepting one or more messages to or from the integrated application to track the user usage of the feature.
